(19) United States
(12) Patent Application Publication
(10) Pub. No.: US 2019/0045757 A1
(43) Pub. Date: Feb. 14, 2019

(54) IN SITU UNDERWATER NET CLEANING APPARATUS

(71) Applicant: Darren Reid, Powell River (CA)

(72) Inventor: Darren Reid, Powell River (CA)

(21) Appl. No.: 16/164,916

(22) Filed: Oct. 19, 2018

Related U.S. Application Data
(63) Continuation-in-part of application No. 15/127,062, filed on Sep. 19, 2016, now Pat. No. 10,136,622.
(60) Provisional application No. 61/955,597, filed on Mar. 19, 2014.

(51) Int. Cl. A01K 63/10; A01K 75/00; B08B 3/02

(52) U.S. Cl. CPC A01K 63/10; B08B 3/024; A01K 75/00

(57) ABSTRACT

The present invention is a highly-efficient, self-propelled apparatus for cleaning nets used for farming of fish and other organisms while the nets are submerged.

In various embodiments, the invention includes two rotating washer head assemblies, with spray bars and corresponding deflector plates. A high-pressure water stream is discharged from the spray bars at an angle that creates a torque force to actuate and maintain rotational movement of the washer head assemblies. The subsequent deflection of the high-pressure water stream by the deflector plates creates a thrusting force to propel the self-propelled apparatus toward the nets.

### CROSS-REFERENCE TO RELATED APPLICATIONS

This patent application claims the benefit of U.S. Provisional Application No. 67/955,597 filed Mar. 19, 2014 and U.S. Non-Provisional Application No. 15/127,062 filed Sep. 19, 2016. The above applications are incorporated by reference.

### FIELD OF INVENTION

This invention relates to the field of cleaning bottoms or walls of ponds or aquaculture receptacles, and more specifically to a net cleaning assembly for cleaning aquaculture nets “in situ.”

### BACKGROUND OF THE INVENTION

Net cleaning is vital to ensuring that fish stock in aquaculture remains healthy and edible. Because aquaculture allows husbandry of marine animals in environments controlled, yet still exposed to the sea, the pens and cages in which the animals are raised can be expanded and supplied with food more readily than on-land fisheries or ones located in smaller bodies of water. This allows for controlled production of large quantities of fish without exacerbating the ecological difficulties caused by over-fishing. However, this open environment also requires constant cleaning.

Fishing nets tend to accumulate naturally occurring marine organisms during seasons notably mussels, bryozoans, and caprillids. As these fouling organisms develop, they restrict life-giving water flow to the penned fish. Left to mature, they harbor harmful bacteria, tax oxygen levels and weigh down attachment points, floatation and anchoring systems. Historically, net cleaning was a reactive measure, foregone until the fouling community had grown enough to become problematic.

Historical net washing procedures involve removing a fouled net and replacing it with a clean one. This process involves substantial equipment, expense, labor and time. Feeding time is often lost and fish experience increased stress due to handling. The fouled net must travel to a land-based facility for washing in huge drums. Once washed, the net must be untangled, feathered out, inspected and repaired of any incidental damage incurred during washing. Drum washing is a significant factor contributing to net degradation.

In an effort to minimize net handling, industry standard practice continues to be coating nets with an active copper compound to delay organic accumulation. This chemical releases ions from the heavy metal, creating a less favorable environment for fouling organisms. While this coating on the net fibers is considered generally effective, its success depends entirely on site specifics and its ionic release capability. The coating is an expensive application. Furthermore, aquaculture experts have reconsidered the coating's use in efforts to maintain the highest standards of environmental sensitivity.

There is an unmet need in the art for a means to rapidly and effectively clean aquaculture nets “in situ”, without resorting to damaging drum washers or expensive, potentially toxic chemical compounds.

### SUMMARY OF THE INVENTION

The invention is a highly-efficient, self-propelled apparatus for cleaning nets used for farming of fish and other organisms while the nets are submerged and in place (in situ).

In various embodiments, the invention includes two rotating washer head assemblies, with corresponding deflector plates, deflector frame assemblies, and a splitter for conducting a single water stream from a high-pressure water source to two separate, hollow stationary shafts. Each stationary shaft conducts the high-pressure water stream through a manifold which divides and conducts the high-pressure stream through a plurality of bent spray bars. The high-pressure water stream is discharged from the bent spray bars at an angle that creates a torque force to actuate and maintain rotational movement of the bent spray bars and rotation of the manifolds. The subsequent deflection of the high-pressure water stream by the deflector plates creates a thrusting force to propel the self-propelled apparatus toward the nets.

### BRIEF DESCRIPTION OF THE DRAWINGS

FIG. 1 illustrates an exemplary highly-efficient, self-propelled apparatus for cleaning aquaculture nets in situ.

FIGS. 2A through 2C illustrate an exemplary splitter for receiving pressurized water through an inlet aperture and releasing pressurized water through two outlets without reducing water pressure or creating excess turbulence.

FIGS. 3A and 3B illustrate an exemplary spreader bar for connecting stationary shafts.

FIGS. 4A and 4B illustrate an exemplary stationary shaft.

FIG. 5A through 5D illustrates an exemplary non-rotational ring connection component.

FIG. 6 illustrates an exemplary bar clamp for securing rotating bent spray bars to a rotating net-protecting plate.

FIGS. 7A and 7B illustrate exemplary angular feet with planar surfaces that connect to deflector support arms and deflector plates.

FIG. 8 illustrates an exemplary embodiment of a computer interface for controlling winch lines.

### DETAILED DESCRIPTION OF THE DRAWINGS

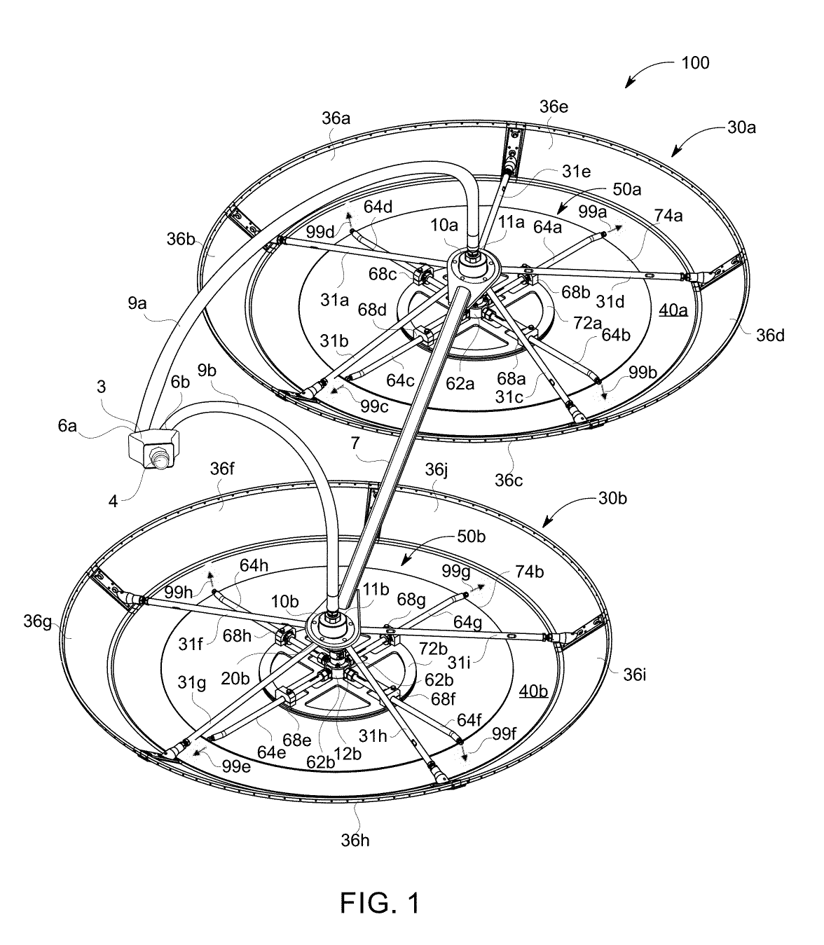

FIG. 1 illustrates highly-efficient, self-propelled apparatus 100 for cleaning nets used for farming of fish and other organisms while the nets are submerged and in place (in situ).

In the exemplary embodiment shown, self-propelled apparatus 100 is comprised of two rotating washer head assemblies 50a and 50b, with corresponding deflector plates 36a through 36e and 36f through 36j, deflector frame assemblies 30a and 30b, and splitter 3 for conducting a single water stream from a high-pressure water source to two separate, hollow stationary shafts 10a and 10b. Stationary shafts 10a and 10b each conduct the high-pressure water stream though rotating manifolds 62a and 62b which each divide and conduct the high-pressure stream through a plurality of rotating bent spray bars 64a through 64d and 64e through 64h. The high-pressure water stream is discharged from rotating bent spray bars 64a through 64h at an angle that creates a rotational torque force as it exits to actuate and maintain rotational movement of the bent spray bars and rotation of manifolds 62a and 62b. The subsequent deflection of the high-pressure water stream by deflector plates 36a through 36j creates a thrusting force to propel self-propelled apparatus 100 toward the nets.

As illustrated in FIG. 1, pressurized water enters apparatus 100 through inlet 4 of splitter 3. The pressured water is released through outlets 6a and 6b to route pressurized water to stationary shafts 10a and 10b.

Spreader bar 7 connects stationary shaft 10a with stationary shaft 10b.

Stationary shaft 10a is operatively coupled with rotating washer head assembly 50a. Rotational outlet 12 of stationary shaft 10a is operatively coupled with rotating manifold 62 of rotating washer head assembly 50a.

Splitter 3 diverts pressurized water equally to shaft inlets 11a and 11b of rotational connection assemblies 10a and 10b through hoses 9a and 9b. The water then exits through rotational outlets 12a and 12b of rotational connection assemblies 10a and 10b to enter inlets in manifolds 62a and 62b. Rotational outlets 12a and 12b rotate independently of shaft inlets 11a and 11b to allow rotating manifolds 62a and 62b to rotate independently of hoses 9a and 9b.

Each rotating manifold 62a and 62b has an outlet that corresponds to each of rotating bent spray bars 64a-64d and to rotating bent spray bars 64e-h, respectively, at a spray bar inlet. Pressurized water enters the spray bar inlet and exits a spray bar outlet, which is operatively coupled with a jet nozzle.

Rotating bent spray bars 64a-d and 64e-h include inner cavity (not shown) and are bent at an angle ranging from approximately 13 degrees to 21 degrees. The bend is formed closer to the outlet of rotating bent spray bar 64 than to the inlet of the spray bar. The distance between the spray bar inlet and the spray bar bend is approximately 20½ inches. The distance between the spray bar bend and the spray bar outlet is approximately 1.4 inches.

Rotating bent spray bars 64a through 64h direct pressurized water toward the net for cleaning. Rotating bent spray bars 64a-d and 64e-h direct pressurized water at an angle that creates a torque force which causes rotating washer head assemblies 50a and 50b to rotate. In various embodiments, rotating washer head assemblies 50a and 50b rotate in opposite directions. The direction of rotation depends on the direction in which the jet nozzles on rotating bent spray bars 64a-d and 64e-h point, which can be adjusted by loosening any of bar clamps 68a through 68h, spinning rotating bent spray bar 64 within the bar clamp, and tightening the bar clamp.

Rotating washer head assembly 50a includes rotating manifold 62a, rotating bent spray bars 64a through 64d, rotating rigid plate 72a, and rotating net protecting plate 74a. Rotating washer head assembly 50b includes rotating manifold 62b, rotating bent spray bars 64e through 64h, rotating rigid plate 72b, and rotating net protecting plate 74b. Bar clamps 68a through 68d are fixedly attached to rotating rigid plate 72a and rotating net protecting plate 74a. Bar clamps 68e through 68h are fixedly attached to rotating rigid plate 72b and rotating net protecting plate 74b.

Bar clamps 68a through 68d secure rotating bent spray bars 64a-64d and 64e-64h to rotating net protecting plates 74a and 74b, causing them to move with rotating manifolds 62a and 62b. Rotating net protecting plates 74a and 74b are of a sufficient radius to extend to the ends of rotating bent spray bars 64a-64h. Rotating net protecting plates 74a and 74b protect nets from becoming entangled and damaged by rotating bent spray bars 64a-64h. In one exemplary embodiment, rotating net protecting plates 74a and 74b are comprised of plastic or Delrin plastic to protect aquaculture nets and to bend to accommodate non-planar surfaces on the nets.

After exiting rotating bent spray bars 64a through 64d, the water stream is dispersed and widens. A portion of the water steam passes under deflector frame assembly 30, but the remaining portion of the water stream is deflected by deflector frame assembly 30, creating thrust to propel apparatus 100 toward the nets in a high-pressure, underwater environment. Rotating bent spray bars 64a through 64d and deflector frame assembly 30 replace thruster jets, engines, and other mechanical means of propulsion required by other devices.

Deflector frame assembly 30 includes non-rotational ring connection component 20, deflector plates 36a through 36e, deflector support arms 31a through 31e. One end of each deflector support arm 31a through 31e is operatively coupled with one deflector plate 36a through 36e and the opposite end of each deflector support arm 31a through 31e is operatively coupled with non-rotational ring connection component 20.

Non-rotational ring connection component 20 attaches to stationary shaft 10. In the exemplary embodiment shown, non-rotational ring connection component 20 is a tapered lock assembly that clamps onto stationary shaft 10, which can be loosened to adjust its position along the length of stationary shaft 10.

In various embodiments, deflector plates 36a through 36e form a frustoconical shroud structure. In various embodiments, deflector plates 36a through 36e are a single, molded piece. In various embodiments, deflector plates 36a through 36e form washer head aperture 40, which is larger than the diameter of rotating net protecting plate 74 and surrounds rotating net protecting plate 74. High pressure water streams 99a through 99h flow freely through washer head aperture 40 to contact the net.

Rotating washer head assemblies 50a and 50b freely rotate, independently of deflector frame assemblies 30a and 30b. In various embodiments, this allows the user to attach cables to deflector frame assemblies 30a and 30b to steer and position apparatus 100 without affecting the rotation of washer head assemblies 50a and 50b.

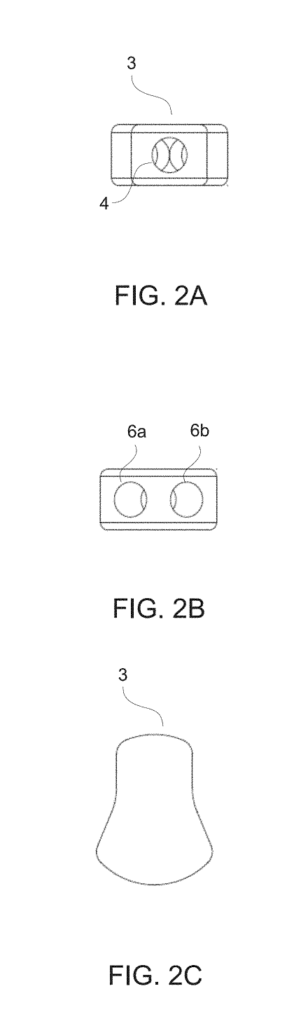

FIGS. 2A through 2C illustrate exemplary splitter 3 for receiving pressurized water through an inlet aperture and releasing pressurized water through two outlets without reducing water pressure or creating excess turbulence.

FIG. 2A is a top view, illustrating inlet 4 of splitter 3. FIG. 2B is a bottom view, illustrating outlets 6a and 6b of splitter 3. FIG. 2C is a side view of splitter 3.

In one exemplary embodiment, splitter 3 is comprised of stainless steel.

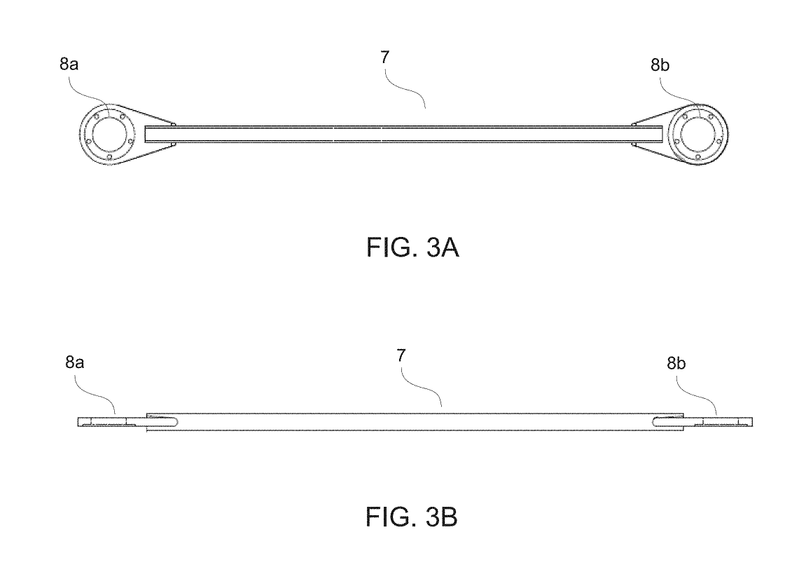

FIGS. 3A and 3B illustrate exemplary spreader bar 7 for connecting stationary shafts 10a and 10b. FIG. 3A is a top view and FIG. 3B is a side view. Stationary shafts 10a and 10b (not shown) are fixedly attached to spreader bar 7. In the exemplary embodiment shown, spreader bar 7 includes spreader bar apertures 8a and 8b to which said stationary shafts 10a and 10b are fixedly attached by bolts or other attachment members.

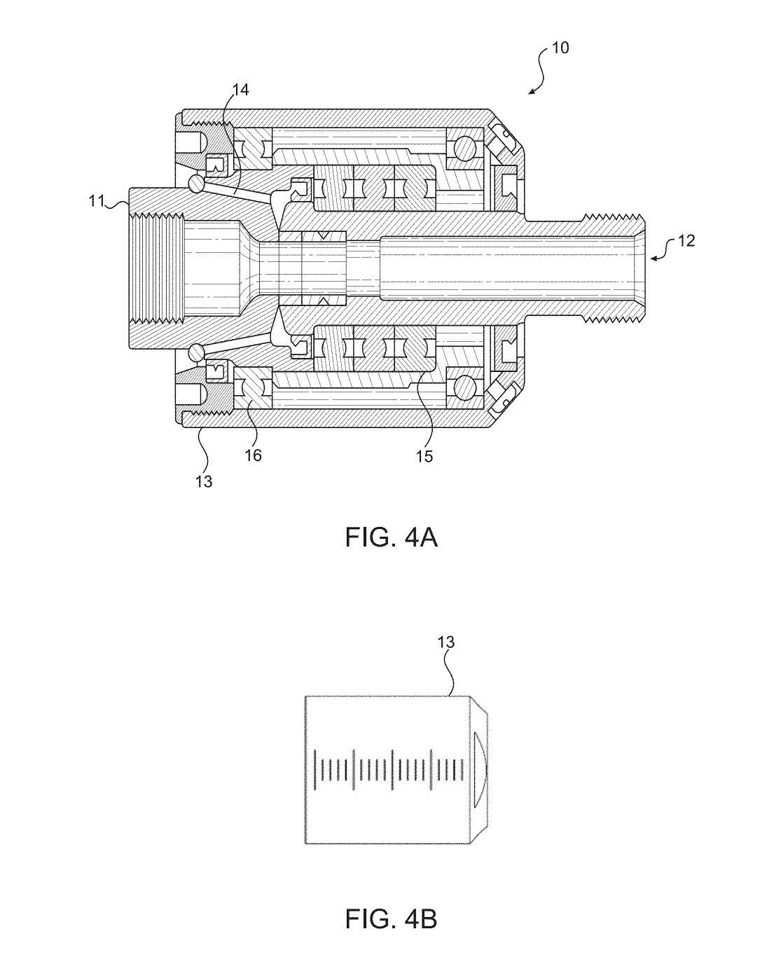

FIGS. 4A and 4B illustrate exemplary stationary shaft 10. As illustrated in FIG. 4A, stationary shaft 10 receives pressurized water through shaft inlet 11 and releases pressurized water through rotational outlet 12 to rotating manifold 62 and has inlet pivot 14, outlet pivot 15, and outer body pivot 16 that allow rotational outlet 12 and rotating manifold 62 to rotate independently of shaft body 13, shaft inlet 11 and a water source connected to shaft inlet 11.

Shaft inlet 11 is located at the upper-most point of stationary shaft 10. Shaft inlet 11 has an approximately one-inch female thread for connecting to a source of pressurized fluid (not shown). In an exemplary embodiment, the source of pressurized fluid may be a high-pressure hose connected to a fluid pump. In an exemplary embodiment, the pressurized fluid may be fresh water or seawater. As further shown in FIG. 4A, rotational outlet 12 is located below shaft inlet 11 within stationary shaft 10. Rotational outlet 12 has an approximately one-inch male thread for connecting to other components. As further shown in FIG. 4A, shaft body 13 surrounds at least part of shaft inlet 11 and rotational outlet 12.

In the exemplary embodiment shown in FIG. 4B, shaft body 13 has etched ring markings along its length to indicate the position of non-rotational ring connection component 20.

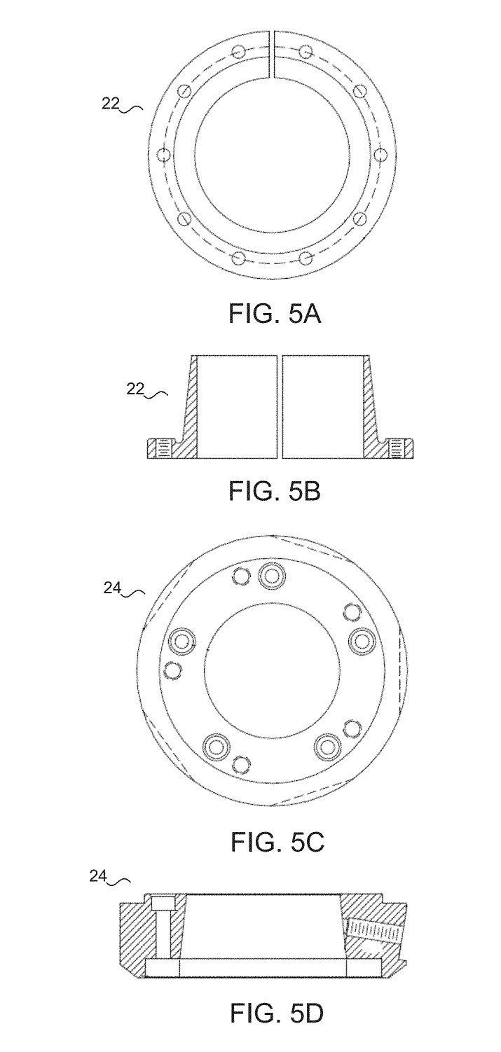

FIGS. 5A through 5D illustrate exemplary non-rotational ring connection component 20. FIG. 5A illustrates a bottom view of inner hub 22. FIG. 5B illustrates a side view of inner hub 22. FIG. 5C illustrates a top view of outer housing 24. FIG. 5D illustrates a side view of outer housing 24.

In the exemplary embodiment shown, non-rotational ring connection component 20 is a tapered lock assembly comprised of inner hub 22 and outer housing 24 that can be loosened to slide along the length of stationary shaft 10 and tightened to secure its position. In the exemplary embodiment shown, inner hub 22 is shaped like a cone with a slot and fits around stationary shaft 10. Outer housing 24 fits around inner hub 22 and compresses it to clamp around stationary shaft 10. In various embodiments, bolts or screws insert into aligned vertical threaded apertures in inner hub 22 and outer housing 24 to secure inner hub 22 to outer housing 24 and compress inner hub 22 to clamp around stationary shaft 10.

In the exemplary embodiment shown, non-rotational ring connection component 20 secures deflector frame assembly 30 to stationary shaft 10.

The position of non-rotational ring connection component 20 determines the distance between deflector plates 36a through 36e and stationary shaft 10a. In various embodiments, this distance adjusts to accommodate the angle at which spray bars 64a through 64d direct a pressurized water stream, relative to rotating net protecting plate 74a. This ensures that the pressurized water streams 99a through 99d discharged by spray bars 64a through 64d are deflected by deflector plates 36a through 36e to create thrust.

In one embodiment, one end of each deflector support arm 31a through 31e attaches to outer housing 24. One end of each deflector support arm 31a through 31e may be threaded to insert into threaded apertures in outer housing 24.

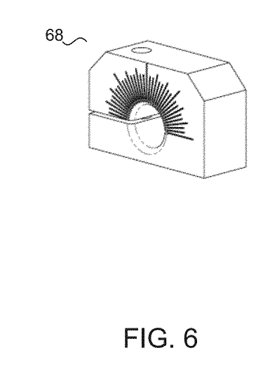

FIG. 6 illustrates exemplary bar clamp 68 for securing rotating bent spray bars 64 to rotating net protecting plate 74. In the exemplary embodiment shown, bar clamp 68 has etched reference markings that can be used as a guide to precisely rotate each rotating bent spray bar 64 within bar clamp 68. In various embodiments, rotating bent spray bar 64 includes one etched line that aligns with the etched markings on bar clamp 68 to indicate the stream angle between water streams 99a through 99d discharged by rotating bent spray bars 64a through 64d point and the planar surface formed by rotating net protecting plate 74 on the net. Rotating bent spray bars 64a through 64d discharge high-pressure water stream 99a through 99d toward the net and the stream angle can be adjusted to aim a larger or smaller percentage of the high-pressure water streams 99a through 99d toward the net. The desired stream angle may depend on the severity of surface fouling present on the net.

In the exemplary embodiment shown, bar clamp 68 only requires one bolt to tighten or loosen the clamp. Bar clamp 68 has one aperture in the top that receives a screw or bolt to tighten the clamp.

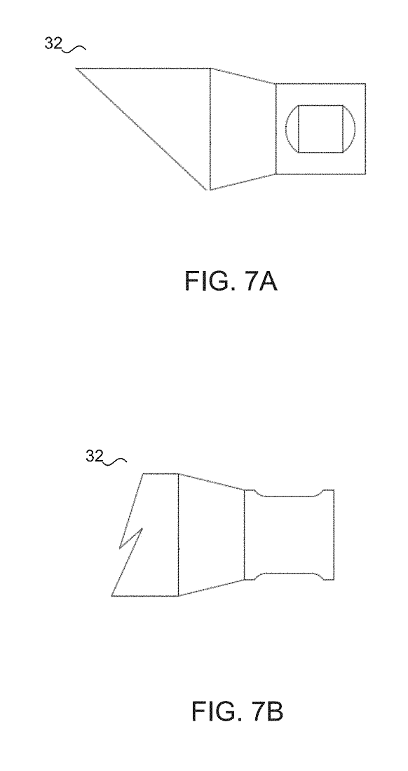

FIGS. 7A and 7B illustrate exemplary angular feet 32 with planar surfaces that connect to deflector support arms 31 and deflector plates 36.

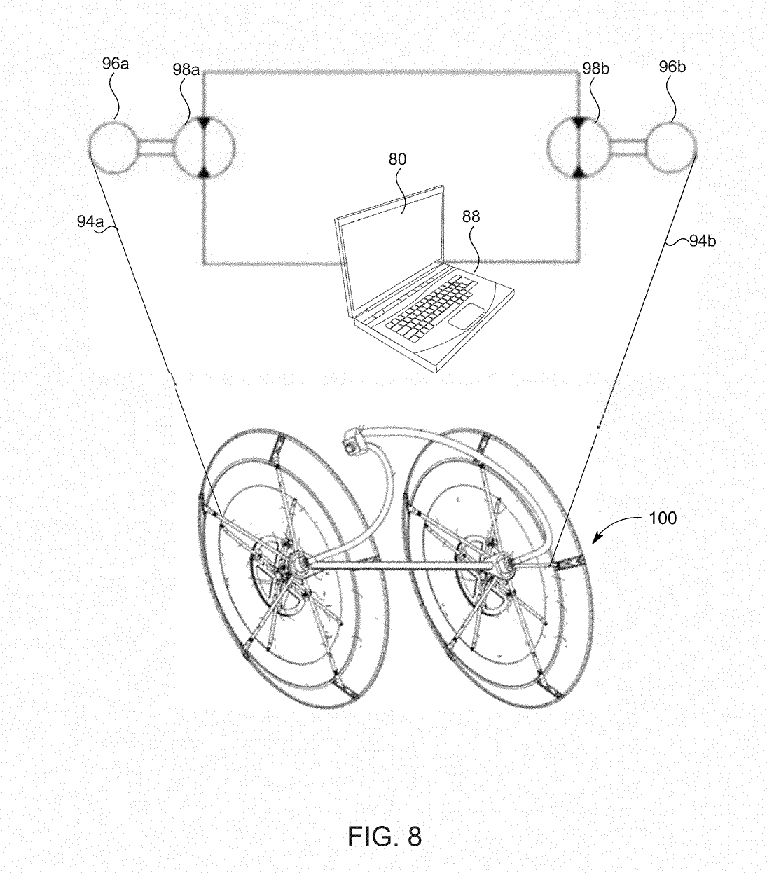

FIG. 8 illustrates an exemplary embodiment of computer interface 80 and computer control unit 88 for controlling winch lines 94a and 94b. In the exemplary embodiment shown, the winch system includes winch lines 94a and 94b. Winch lines 94a and 94b are cables or other rope-like structures attached to apparatus 100 and winch spools 96a and 96b.

Winch spools 96a and 96b rotate to release or retrieve lengths of winch lines 94a and 94b. Winch spools 96a and 96b are operatively coupled with hydraulic proportional control valves 98a and 98b, which are opened and closed by computer control unit 88 to control the amount of hydraulic fluid released to spool winch lines 94a and 94b proportionally. In various embodiments, winch lines 94a and 94b are attached to deflector support arms 31e and 31g or deflector support arms located at the 10 o'clock and 2 o'clock positions of apparatus 100. Apparatus 100 may connect to more than two winch lines.

Computer control unit 88 receives user input parameters through computer interface 80 to define the area of the net to be cleaned. Computer control unit 88 calculates the path of self-propelled apparatus 100 based on the area of the net defined by the user input. Computer control unit 88 further calculates the amount of each winch line 94a and 94b to be released or retrieved (line count) and synchronizes the timing of the release and retrieval of each winch line to move apparatus 100 on the calculated path.

Computer control unit 88 calculates the amount of hydraulic fluid to release, corresponding to the amount of winch line to be released or retrieved at a calculated time. Computer control unit 88 actuates hydraulic proportional control valves 98a and 98b to release the calculated amount of hydraulic fluid. Computer control unit 88 ensures that the user-defined area is cleaned and controls the direction of travel of self-propelled apparatus 100 at any given point in time.

In various embodiments, computer control unit 88 receives user inputs to control the initial horizonal and vertical positioning of self-propelled apparatus 100. In other embodiments, computer control unit 88 receives user input to control the speed and timing at which winch lines 94a and 94b are released and retrieved. In still other embodiments, computer control unit 88 can be used to define patterns and paths of movement of self-propelled apparatus 100 for washing nets. For example, computer control unit 88 may receive parameters for a path which passes over the same portions of a net more than one time to address heavily fouled areas.

In various embodiments, computer control unit 88 may be used to control the timing at which winch lines 94a and 94b are released and retrieved within a user-defined area and may receive input to pause “wash strokes” by entering a parameter for an interval of time between release and retrieval cycles. In still other embodiments, computer control unit 88 may receive various parameters which control winch line tension by releasing a calculated amount of hydraulic fluid by opening or closing hydraulic proportional control valves 98a and 98b.

What is claimed is:

1. An in situ net cleaning apparatus comprised of:
a plurality of rotating bent spray bars;
a rotating manifold;
a rotating net protecting plate; and
one or more deflector plates.

2. The apparatus of claim 1 wherein said plurality of rotating bent spray bars discharge a water stream directed at a net and one or more deflector plates, to create a thrust force to propel said in situ net cleaning apparatus.

3. The apparatus of claim 1, which further includes two or more rotating washer head assemblies, wherein each of said two or more rotating washer head assemblies is comprised of:
a plurality of rotating bent spray bars;
a rotating manifold; and
a rotating net protecting plate.

4. The apparatus of claim 3, which further includes a splitter and two or more hollow stationary shafts for conducting water to each of said two or more rotating washer head assemblies.

5. The apparatus of claim 3, wherein said water stream is directed through said two or more rotating manifolds and discharged through said two or more pluralities of rotating bent spray bars.

6. The apparatus of claim 5, wherein discharge of said water stream through said two or more pluralities of rotating bent spray bars creates a rotational force to actuate and maintain rotational movement of said rotating bent spray bars.

7. The apparatus of claim 5, wherein discharge of said water stream is directed at said one or more deflector plates and contact of said water stream with said one or more deflector plates creates a thrusting force to propel said in situ net cleaning apparatus while submerged.

8. The apparatus of claim 1, wherein each of said plurality of rotating bent spray bars is bent at an angle ranging from approximately 13 degrees to 21 degrees.

9. The apparatus of claim 1, wherein the distance between a spray bar inlet and a spray bar bend is greater than the distance between a spray bar outlet and said spray bar bend.

10. The apparatus of claim 1, which further includes a deflector frame comprised of a plurality of deflector support arms, which supports said one or more deflector plates in a stationary position.

11. The apparatus of claim 1, wherein said one or more deflector plates forms a frustoconical shroud structure.

12. The apparatus of claim 10, wherein said deflector frame is affixed to said one or more deflector plates and a stationary shaft.

13. The apparatus of claim 12, wherein said deflector frame is comprised of components selected from a group consisting of a non-rotational ring connection component, a plurality of deflector support arms and a plurality of angular feet.

14. The apparatus of claim 13, wherein said non-rotational ring connection component is a tapered lock assembly.

15. The apparatus of claim 3, wherein each of said two or more rotating washer head assemblies rotate independently of said one or more deflector plates.

16. The apparatus of claim 1, which further includes one or more hydraulic proportional control valves which release a quantity of hydraulic fluid to actuate at least two winch spools which retrieve and release at least two winch lines.

17. The apparatus of claim 16, wherein each of said at least two winch lines are attached to a deflector support arm.

18. The apparatus of claim 17, which further includes a computer control unit which calculates the amount of each of said at least two winch lines to be released or retrieved based on a path defined by user input parameters.

19. The apparatus of claim 18, wherein said computer control unit synchronizes the timing of the release and retrieval of each of said at least two winch lines to move said apparatus on said path.

20. The apparatus of claim 19, wherein said computer control unit receives user inputs selected from a group consisting of a user defined area of a net to be cleaned, direction of travel, the speed and timing at which each of said at least two winch lines is released and retrieved, patterns and paths of movement of said apparatus, washing patterns, wash stroke patterns, and intervals between retrieve and release cycles.
